(19) United States
(12) Patent Application Publication
(10) Pub. No.: US 2025/0378819 A1
(43) Pub. Date: Dec. 11, 2025

(54) TRAINING OF A SPEECH RECOGNITION MODEL

(71) Applicants: Beijing Zitiao Network Technology Co., Ltd., Beijing (CN); Lemon Inc., Grand Cayman (KY)

(72) Inventors: Chen Shen, Beijing (CN); Lu Lu, Los Angeles, CA (US)

(21) Appl. No.: 19/231,864

(22) Filed: Jun. 9, 2025

(30) Foreign Application Priority Data
Jun. 11, 2024 (CN) 202410749921.1

(51) Int. Cl. G10L 15/06; G10L 15/01; G10L 15/02; G10L 15/183

(52) U.S. Cl. CPC G10L 15/063; G10L 15/01; G10L 15/02; G10L 15/183

(57) ABSTRACT

Embodiments of the disclosure relate to a method, apparatus, device and storage medium for training a speech recognition model that includes an encoding model and a language model. An example method includes: generating, with the encoding model, a speech feature sequence of a speech sample; processing, with the language model, the speech feature sequence to generate probability information; providing the speech feature sequence to a reference model corresponding to the language model, to obtain a set of recognized texts corresponding to the speech sample; determining a training loss based on the probability information, the set of recognized texts, and a labeled text corresponding to the speech sample; and adjusting parameters of the speech recognition model based on the training loss.

### CROSS-REFERENCE

This application claims the priority of Chinese Patent Application No. 202410749921.1 entitled “METHOD, APPARATUS, DEVICE AND STORAGE MEDIUM FOR TRAINING A SPEECH RECOGNITION MODEL,” filed on Jun. 11, 2024, the entire content of which is incorporated herein by reference.

### FIELD

Example embodiments of the present disclosure generally relate to the field of computers, and in particular, to training of a speech recognition model.

### BACKGROUND

With the development of the Internet and computer technology, speech recognition has become an important basic capability. For example, some solutions can use speech recognition models based on machine learning to perform speech recognition tasks. The training process of the speech recognition model will directly affect the recognition accuracy of the speech recognition model.

### SUMMARY

In a first aspect of the present disclosure, a method for training a speech recognition model is provided. The method includes: generating, with the encoding model, a speech feature sequence of a speech sample; processing, with the language model, the speech feature sequence to generate probability information; providing the speech feature representation to a reference model corresponding to the language model, to obtain a set of recognized texts corresponding to the speech sample; determining a training loss based on the probability information, the set of recognized texts, and a labeled text corresponding to the speech sample; and adjusting parameters of the speech recognition model based on the training loss.

In a second aspect of the present disclosure, an apparatus for training a speech recognition model is provided. The apparatus includes: a generating module configured to generate, with the encoding model, a speech feature sequence of a speech sample; a predicting module configured to process, with the language model, the speech feature sequence to generate probability information; a providing module configured to provide the speech feature representation to a reference model corresponding to the language model, to obtain a set of recognized texts corresponding to the speech sample; a determining module configured to determine a training loss based on the probability information, the set of recognized texts, and a labeled text corresponding to the speech sample; and an adjusting module configured to adjust parameters of the speech recognition model based on the training loss.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a block diagram of an example speech recognition model in which embodiments according to the present disclosure may be implemented;

FIG. 2 illustrates a flowchart of an example process of training a speech recognition model according to some embodiments of the present disclosure;

FIG. 3 illustrates an example training block diagram according to some embodiments of the present disclosure;

FIG. 4 is a schematic structural block diagram of an example apparatus for training a speech recognition model according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the term “including” and the like should be understood to include “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

The embodiments of the present disclosure may involve data of the user, obtaining and/or using the data, and the like. These aspects all follow the corresponding laws and regulations and related regulations. In the embodiments of the present disclosure, all data is collected, obtained, processed, handled, forwarded, used, etc., all of which are performed on the premise the knowledge and confirmation of the user. Accordingly, in a case where implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As mentioned above, the training process of the speech recognition model will directly affect the recognition accuracy of the speech recognition model. For example, conventional training may perform end-to-end training based on differences between decoding results and labeling results, however, an efficiency of such a training is relatively low since the decoding process takes longer.

Embodiments of the present disclosure provide a solution for training a speech recognition model. The solution includes: generating, with the encoding model, a speech feature sequence of a speech sample; processing, with the language model, the speech feature sequence to generate probability information; providing the speech feature representation to a reference model corresponding to the language model, to obtain a set of recognized texts corresponding to the speech sample; determining a training loss based on the probability information, the set of recognized texts, and a labeled text corresponding to the speech sample; and adjusting parameters of the speech recognition model based on the training loss.

In this way, the embodiments of the present disclosure can train the speech recognition model based on a reinforcement learning manner, thereby improving the training efficiency of the speech recognition model.

Various example implementations of this scheme are described in detail below in conjunction with the accompanying drawings.

### Example Speech Recognition Model

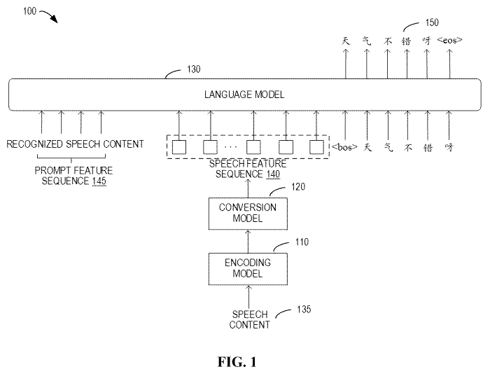

FIG. 1 illustrates a block diagram of an example speech recognition model 100 in which embodiments according to the present disclosure may be implemented.

As shown in FIG. 1, the speech recognition model 100 may include three sub-models, namely an encoding model 110, a conversion model 120, and a language model 130. As shown in FIG. 1, the encoding model 110 may be configured to obtain speech content 135 to encode it as an intermediate feature representation.

Further, the conversion model 120 may convert the intermediate feature representation into a speech feature sequence 140, also referred to as a speech embedding representation or a speech token. For example, the conversion model 120 may use a linear layer to map the intermediate feature representation to a feature dimension corresponding the language model 130.

Accordingly, the language model 130 may be configured to generate a speech recognition result 150 corresponding to the speech content 135 based on the received input feature sequence. Such an input feature sequence may include, for example, a prompt feature sequence 145 and a speech feature sequence 140. The prompt feature sequence 145 may correspond to a predetermined prompt item to instruct the language model 130 to perform the speech recognition task.

In some embodiments, the language model 130 may output a speech recognition result based on Next Token Prediction (NTP). As shown in FIG. 1, <bos> (beginning of sentence) represents the start-of-sentence identifier, and <eos> (end of sentence) represents the end-of-sentence identifier.

As shown in FIG. 1, in predicting the output token, the language model 130 may predict the next output token based on the existing token sequence. For example, the language model 130 may output text tokens corresponding to the speech content 135 in sequence, for example, “Tian” ( [symbol] ), “qi” ( [symbol] ) “bu” ( [symbol] ), “cuo” ( [symbol] ), and “ya” ( [symbol] ).

As such, the speech recognition model 100 may use the language model 130 to achieve recognition for the speech content 135. The training process of the speech recognition model 100 will be further described below.

### Example Process

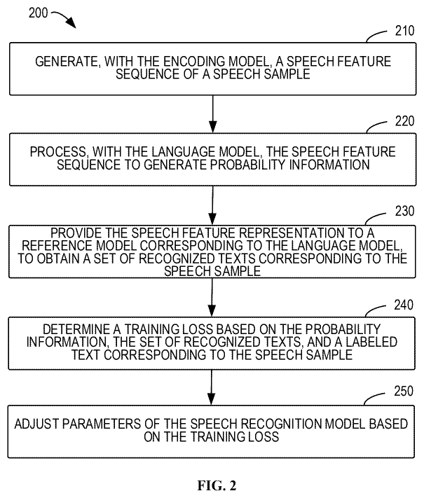

FIG. 2 illustrates a flowchart of an example process 200 of training a speech recognition model according to some embodiments of the present disclosure. The process 200 may be implemented at an appropriate electronic device. The process 200 is described below with reference to FIG. 1.

As shown in FIG. 2, at block 210, the electronic device generates, with the encoding model, a speech feature sequence of a speech sample.

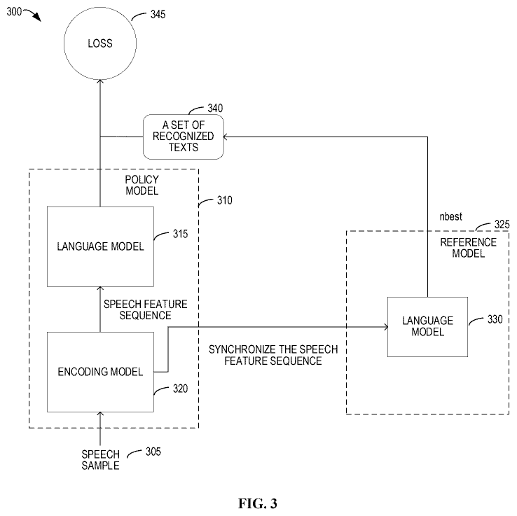

A training framework 300 according to some embodiments of the present disclosure will be described below with reference to FIG. 3. As shown in FIG. 3, a policy model 310 may be deployed, for example, at a first device, also referred to as a training device. A reference model 325 may be deployed, for example, at a second device, also referred to as a decoding device.

As shown in FIG. 3, the policy model 310 may include, for example, a speech recognition model to be trained, which may include an encoding model 320 and a language model 315. In some examples, the policy model 310 may further include, for example, a conversion model as shown in FIG. 1.

In some embodiments, the reference model 325 may include a language model 330. In some embodiments, the language model 330 may be initialized with parameters of the language model 315 in the policy model 310. In the reinforcement learning process, parameters of the language model 330 may, for example, remain unchanged.

In some embodiments, the policy model 310 may include, for example, a speech recognition model 100 trained by a self-supervised training process and a supervised training process. The reinforcement learning process described in FIG. 2 may further optimize such a speech recognition model 100.

As shown in FIG. 3, the training device may process the speech samples 305 by using the encoding model 320 and a conversion model (not shown) to generate a speech feature sequence.

At block 220, the training device processes, with the language model, the speech feature sequence to generate probability information. Specifically, as shown in FIG. 3, the training device may process, with the language model 315, the input feature sequence constructed based on the speech feature sequence, and generate probability information (also referred to as logits). The construction process of the input feature sequence and the processing process of the language model ay refer to the content described in FIG. 1, and details are not described herein again.

At block 230, the training device provides the speech feature representation to a reference model corresponding to the language model, to obtain a set of recognized texts corresponding to the speech sample.

In particular, the training device may provide the generated speech feature sequence to the language model 330. Further, the language model 330 may process an input feature sequence constructed based on the speech feature sequence, and may perform a decoding process to generate a set of recognized texts 340 (also referred to as nbest, i.e., the n best recognition results).

In some embodiments, the language model 330 may determine a set of recognized text 340, e.g., the n best recognition results, based on a beam search process.

With continued reference to FIG. 2, in block 240, the training device determines a training loss based on the probability information, the set of recognized texts, and a labeled text corresponding to the speech sample.

Specifically, the training device may determine a set of probabilities corresponding to the set of recognized text 340 based on the probability information output by the language model 315. Further, the training device may further determine, based on the labeled text, evaluation information of the set of recognized texts 340.

In some embodiments, such evaluation information may include, for example, a Word Error Rate (WER) and/or a Weighted Word Error Rate (WWER) determined based on the labeled text.

Further, the training device may determine a training loss 345 based on the set of probabilities and corresponding evaluation information. For example, the above process may be expressed as:

$${L}_{w e r / w e r r}^{N - b e s t} = {\sum }_{{y}_{i} ∈ B e a m ( x \cdot N )} \hat{P} ( {y}_{i} \vert x ) [ W ( {y}_{{i}^{′}} {y}^{⋆} ) - \hat{W} ] \qquad ( 1 )$$

where \hat{P}(yᵢ|x) represents the posterior probability of the set of recognized texts 340 determined based on the probability information output by the language model 315, with x representing the speech feature sequence, N representing the number of recognized texts output by the language model 330, and Beam representing the beam search process; W(yᵢ, y*) represents the WER or WWER between the recognized text yᵢ and the labeled text y*; Ŵ represents the average WER or average WWER of the set of recognized texts.

At block 250, parameters of the speech recognition model are adjusted based on the training loss.

In some embodiments, during the process of adjusting the policy model 310 based on the training loss 345 determined according to formula (1), the training device may, for example, adjust at least the parameters of the encoding model 320. In some embodiments, parameters of the conversion model may be fixed, for example.

In some embodiments, during the reinforcement learning process, the training device may also fix parameters of the language model 315, for example. Alternatively, the training device may fine-tune the parameters of the language model 315. As a further example, the training device may, for example, also adjust parameters of a fine-tuning module associated with the language model 315. For example, the training device may adjust parameters of a Low-Rank Adaptation (Lora) module associated with the language model 315.

In some embodiments, as mentioned above, to improve the decoding efficiency of the reference model 325, the reference model 325 may be deployed at a further device (e.g., a decoding device) different from the training device. In some embodiments, considering that decoding requires a relatively longer time, the computing capability of the decoding device may, for example, be higher than that of the training device.

In this way, the embodiments of the present disclosure are able to train the speech recognition model based on a reinforcement learning manner, thereby improving the training efficiency of the speech recognition model.

### Example Apparatus and Device

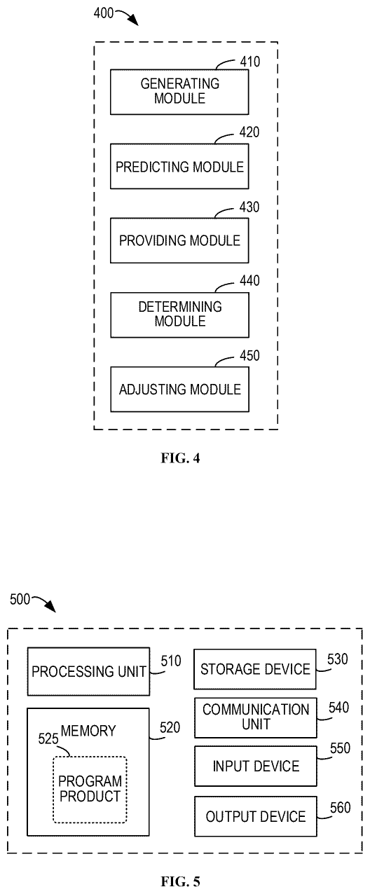

The embodiments of the present disclosure also provide a corresponding apparatus for implementing the above method or process. FIG. 4 is a schematic structural block diagram of an example apparatus 400 for training a speech recognition model according to some embodiments of the present disclosure. The apparatus 400 may be implemented or included in an electronic device. The various modules/components in the apparatus 400 may be implemented by hardware, software, firmware, or any combination thereof.

As shown in FIG. 4, the apparatus 400 includes a generating module 410 configured to generate, with the encoding model, a speech feature sequence of a speech sample; a predicting module 420 configured to process, with the language model, the speech feature sequence to generate probability information; a providing module 430 configured to provide the speech feature representation to a reference model corresponding to the language model, to obtain a set of recognized texts corresponding to the speech sample; a determining module 440 configured to determine a training loss based on the probability information, the set of recognized texts, and a labeled text corresponding to the speech sample; and an adjusting module 450 configured to adjust parameters of the speech recognition model based on the training loss.

In some embodiments, the speech recognition model further includes a conversion model, and the generating module 410 is further configured to: process the speech sample with the encoding model to generate an intermediate feature representation; and convert, with the conversion model, the intermediate feature representation into the speech feature sequence.

In some embodiments, the set of recognized text includes a set of recognized texts determined by the reference model based on a beam search process.

In some embodiments, the determining module 440 is further configured to: determine, based on the probability information, a set of probabilities corresponding to the set of recognized texts; determine, based on the labeled text, evaluation information of the set of recognized texts; and determine the training loss based on the set of probabilities and the corresponding evaluation information.

In some embodiments, the determining module 440 is further configured to determine, based on the labeled text, a word error rate and/or a weighted word error rate of the set of recognized texts.

In some embodiments, the adjusting module 450 is further configured to adjust the parameters of the encoding model in the speech recognition model based on the training loss.

In some embodiments, the adjusting module 450 is further configured to: fix the parameters of the language model; fine-tune the parameters of the language model; or adjust parameters of a fine-tuning module associated with the language model.

In some embodiments, the language model is deployed at a first device, and the reference model is deployed at a second device.

In some embodiments, a computing capability of the second device is higher than the first device.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely example and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of the electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, a computer-readable storage medium having computer-executable instructions stored thereon is provided, where the computer program is executable by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for training a speech recognition model comprising an encoding model and a language model, the method comprising:
generating, with the encoding model, a speech feature sequence of a speech sample;
processing, with the language model, the speech feature sequence to generate probability information;
providing the speech feature sequence to a reference model corresponding to the language model, to obtain a set of recognized texts corresponding to the speech sample;
determining a training loss based on the probability information, the set of recognized texts, and a labeled text corresponding to the speech sample; and
adjusting parameters of the speech recognition model based on the training loss.

2. The method of claim 1, wherein the speech recognition model further comprises a conversion model, and generating, with the encoding model, the speech feature sequence of the speech sample comprises:
processing the speech sample with the encoding model to generate an intermediate feature representation; and
converting, with the conversion model, the intermediate feature representation into the speech feature sequence.

3. The method of claim 1, wherein the set of recognized text comprises a set of recognized texts determined by the reference model based on a beam search process.

4. The method of claim 1, wherein determining the training loss based on the probability information, the set of recognized texts, and a labeled text corresponding to the speech sample comprises:
determining, based on the probability information, a set of probabilities corresponding to the set of recognized texts;
determining, based on the labeled text, evaluation information of the set of recognized texts; and
determining the training loss based on the set of probabilities and the corresponding evaluation information.

5. The method of claim 4, wherein determining, based on the labeled text, the evaluation information of the set of recognized texts comprises:
determining, based on the labeled text, at least one of a word error rate or a weighted word error rate of the set of recognized texts.

6. The method of claim 1, wherein adjusting the parameters of the speech recognition model based on the training loss comprises:
adjusting the parameters of the encoding model in the speech recognition model based on the training loss.

7. The method of claim 6, wherein adjusting the parameters of the speech recognition model based on the training loss further comprises:
fixing the parameters of the language model;
fine-tuning the parameters of the language model; or
adjusting parameters of a fine-tuning module associated with the language model.

8. The method of claim 1, wherein the language model is deployed at a first device, and the reference model is deployed at a second device.

9. The method of claim 8, wherein a computing capability of the second device is higher than the first device.

10. An electronic device, comprising:
at least one processor; and
at least one memory coupled to the at least one processor and storing instructions for execution by the at least one processor, the instructions, when executed by the at least one processor, causing the electronic device to perform operations comprising:
generating, with an encoding model of a speech recognition model, a speech feature sequence of a speech sample;
processing, with a language model of a speech recognition model, the speech feature sequence to generate probability information;
providing the speech feature sequence to a reference model corresponding to the language model, to obtain a set of recognized texts corresponding to the speech sample;
determining a training loss based on the probability information, the set of recognized texts, and a labeled text corresponding to the speech sample; and
adjusting parameters of the speech recognition model based on the training loss.

11. The electronic device of claim 10, wherein the speech recognition model further comprises a conversion model, and generating, with the encoding model, the speech feature sequence of the speech sample comprises:
processing the speech sample with the encoding model to generate an intermediate feature representation; and
converting, with the conversion model, the intermediate feature representation into the speech feature sequence.

12. The electronic device of claim 10, wherein the set of recognized text comprises a set of recognized texts determined by the reference model based on a beam search process.

13. The electronic device of claim 10, wherein determining the training loss based on the probability information, the set of recognized texts, and a labeled text corresponding to the speech sample comprises:
determining, based on the probability information, a set of probabilities corresponding to the set of recognized texts;
determining, based on the labeled text, evaluation information of the set of recognized texts; and
determining the training loss based on the set of probabilities and the corresponding evaluation information.

14. The electronic device of claim 13, wherein determining, based on the labeled text, the evaluation information of the set of recognized texts comprises:
determining, based on the labeled text, a word error rate and/or a weighted word error rate of the set of recognized texts.

15. The electronic device of claim 10, wherein adjusting the parameters of the speech recognition model based on the training loss comprises:
adjusting the parameters of the encoding model in the speech recognition model based on the training loss.

16. The electronic device of claim 15, wherein adjusting the parameters of the speech recognition model based on the training loss further comprises:
fixing the parameters of the language model;
fine-tuning the parameters of the language model; or
adjusting parameters of a fine-tuning module associated with the language model.

17. The electronic device of claim 10, wherein the language model is deployed at a first device, and the reference model is deployed at a second device.

18. The electronic device of claim 17, wherein a computing capability of the second device is higher than the first device.

19. A non-transitory computer-readable storage medium having a computer program stored thereon, the computer program being executable by at least one processor to implement operations comprising:
generating, with an encoding model of a speech recognition model, a speech feature sequence of a speech sample;
processing, with a language model of a speech recognition model, the speech feature sequence to generate probability information;
providing the speech feature sequence to a reference model corresponding to the language model, to obtain a set of recognized texts corresponding to the speech sample;
determining a training loss based on the probability information, the set of recognized texts, and a labeled text corresponding to the speech sample; and
adjusting parameters of the speech recognition model based on the training loss.

20. The non-transitory computer-readable storage medium of claim 19, wherein the speech recognition model further comprises a conversion model, and generating, with the encoding model, the speech feature sequence of the speech sample comprises:
processing the speech sample with the encoding model to generate an intermediate feature representation; and
converting, with the conversion model, the intermediate feature representation into the speech feature sequence.
